(19) United States
(12) Patent Application Publication
(10) Pub. No.: US 2018/0014696 A1
(43) Pub. Date: Jan. 18, 2018

(54) Non-Integrated Motor Fan in Kitchen Appliance

(71) Applicant: Hamilton Beach Brands, Inc., Glen Allen, VA (US)

(72) Inventor: Brian P. Williams, Midlothian, VA (US)

(21) Appl. No.: 15/646,323

(22) Filed: Jul. 11, 2017

Related U.S. Application Data
(60) Provisional application No. 62/361,777, filed on Jul. 13, 2016.

(51) Int. Cl. A47J 43/08; A47J 43/07; H02K 5/20; H02K 9/06

(52) U.S. Cl. CPC A47J 43/085; H02K 9/06; A47J 43/0716; H02K 5/20; A47J 2202/00

(57) ABSTRACT

A blender for blending foodstuff comprises a base and a blender jar removably mountable to the base. The base encloses a motor and a cooling fan. The cooling fan is selectively operable and positioned to blow or draw air across at least a portion of the motor. The blender jar has one or more selectively rotatable blades. The motor is selectively operable to rotate the blender jar blades. The selective operation of the motor is independent of the selective operation of the fan, such that (1) the fan is operable when the motor is not operating, (2) the motor is operable when the fan is not operating, and (3) the fan and the motor are operable at different respective speeds at a same time.

### CROSS-REFERENCE TO RELATED APPLICATIONS

This application is a non-provisional of and claims priority to U.S. Provisional Patent Application Ser. No. 62/361,777, filed Jul. 13, 2016, the contents of which are incorporated herein by reference in its entirety.

### BACKGROUND OF THE DISCLOSURE

The present disclosure relates generally to small appliances, and more particularly to blenders.

Kitchen countertop appliances, such as blenders, incorporate electric motors operable to slice, dice, crush, mix, blend or otherwise process food and drink products. The motors, generally operating at speeds of thousands to tens of thousands of rotations per minute, must be cooled to operate efficiently. Typically, electric appliance motors are cooled by a fan integral to the motor wherein the fan blows air on or draws air over the motor during operation. Notably, conventional cooling fans are integrated onto the motor shaft. The integration of the fan onto the motor shaft means that whenever the motor is operating the fan is operating, and always at the same rotational speed.

Having the motor and fan always operate at the same time and at the same speed, as is conventional, has disadvantages. It may be desirable to operate the fan when the motor is not operating, such as to continue to cool the motor after the motor has finished operating. This, however, is not possible with conventional motor/fan arrangements. Further, it may be desirable to operate the motor without the fan operating, as the motor may not need to be cooled when the motor first begins operating. Being able to operate only the motor when the fan is not needed reduces noise. Again, this is not possible with conventional motor/fan arrangements. Yet, further, it may be desirable for the motor and fan to operate at different rotational speeds (revolutions per minute (RPM)), but this is not possible with conventional motor/fan arrangements.

In light of the above and other shortcomings with current blender motor cooling regimes, there is a need for a new motor/fan arrangement that enables independent control of the motor and cooling fan. The blender of the following disclosure accomplishes the above and other objectives and overcomes at least the above-described disadvantages of conventional blenders.

### BRIEF SUMMARY OF THE DISCLOSURE

A blender for blending foodstuff is disclosed herein. In one embodiment of the subject device, a blender comprises a base and a blender jar removably mountable to the base. The base encloses a motor and a cooling fan. The cooling fan is selectively operable and positioned to blow or draw air across at least a portion of the motor. The blender jar has one or more selectively rotatable blades. The motor is selectively operable to rotate the blender jar blades. The selective operation of the motor is independent of the selective operation of the fan, such that (1) the fan is operable when the motor is not operating, (2) the motor is operable when the fan is not operating, and (3) the fan and the motor are operable at different respective speeds at a same time.

The blender may further comprise a thermostat for measuring a temperature of the motor. The fan may operate when the measured temperature is above a first predetermined temperature limit, and the fan may not operate when the measured temperature is below a second predetermined temperature limit. The first predetermined temperature limit may not bet equal to the second predetermined temperature limit.

Another aspect of the present disclosure is directed to a method of operating a blender appliance. The method comprises (a) receiving a user input via a control panel of a blender; (b) operating the motor as indicated by the user input; (c) measuring a temperature of the motor; (d) comparing the measured temperature to a first predetermined temperature limit and to a second predetermined temperature limit; (e) operating the fan if the measured temperature is above the first predetermined temperature limit; and (f) not operating the fan if the measured temperature is below the second predetermined temperature limit.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there are shown in the drawings embodiments which are presently preferred. It should be understood, however, that the disclosure is not limited to the precise arrangements and instrumentalities shown. In the drawings:

FIG. 1 is a perspective view from the front and top of a blender, according to one embodiment of the present disclosure.

FIG. 2 is a perspective view from the front and top of the base of the blender of FIG. 1.

FIG. 3 is a perspective view from the bottom and rear the base of FIG. 2.

FIG. 4 is a side cross-sectional view of the base of FIG. 2.

FIG. 5 is a block diagram of a control system of a blender, according to one embodiment of the present disclosure.

### DETAILED DESCRIPTION OF THE DISCLOSURE

Certain terminology is used in the following description for convenience only and is not limiting. The words “lower,” “bottom,” “upper,” and “top” designate directions in the drawings to which reference is made. The words “inwardly,” “outwardly,” “upwardly” and “downwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

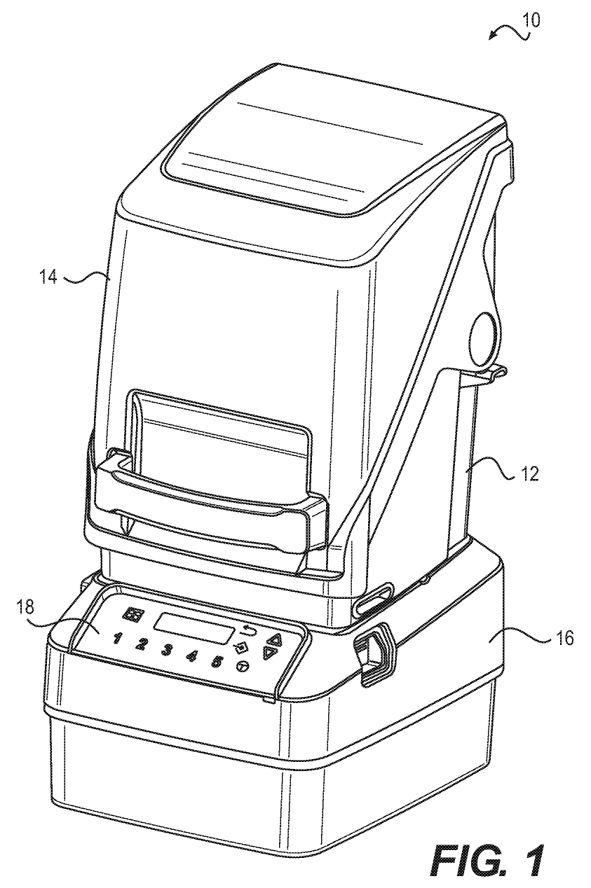

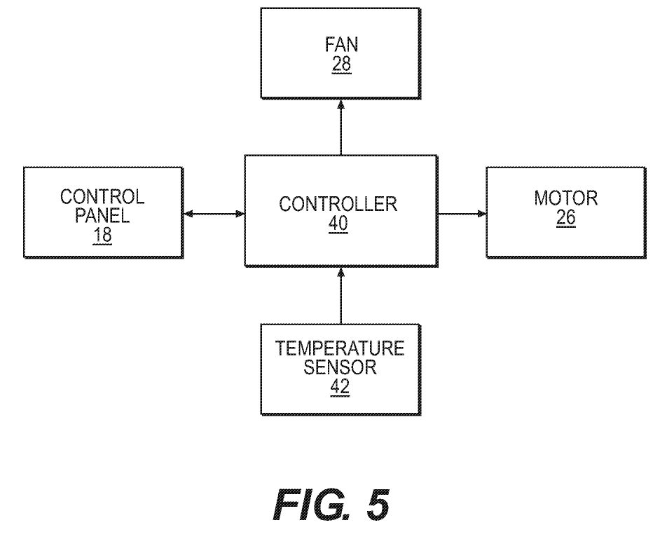

Referring to the drawings in detail, wherein like numerals indicate like elements throughout, FIGS. 1-5 illustrate a blender 10 in accordance with embodiments of the present disclosure. Turning first to FIGS. 1-3, there is illustrated a blender 10 having a blender jar enclosure mounted onto a blender base or motor housing 16. The blender jar enclosure comprises a static lower portion 12 and a rotatable upper portion 14. With the upper portion 14 of the enclosure rotated upward into an open position (not illustrated), a blender jar (not illustrated) may be selectively placed into the enclosure and onto the base 16. The upper portion 14 may then be rotated downward into a closed position (as seen in FIG. 1) for the blending operation. While FIGS. 1-5 illustrate a blender having a blender jar enclosure, embodiments of the present disclosure may be used with any suitable blender or other similar appliance, such as a blender that does not have a blender jar enclosure.

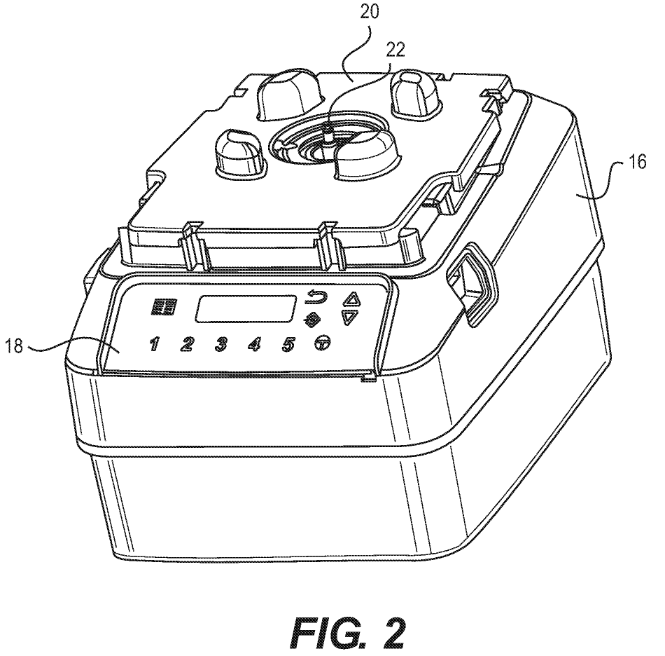

With the blender jar enclosure removed in FIG. 2, it is seen that the top surface of the housing 16 includes a blender jar pad 20. Pad 20 mates with or otherwise supports the blender jar when the blender jar is in place on the base 16. A rotatable shaft 22 protrudes upward through a hole defined in the pad 20. The rotatable shaft 22 may comprise the motor shaft itself, or may be separate from but driven by the motor shaft. In either case, the rotatable shaft 22 rotates when the motor is activated. The rotatable shaft 22 engages with the underside of the blender jar to cause blades within the blender jar to rotate when the rotatable shaft 22 rotates. In an alternative embodiment (not illustrated), the blender base may comprise a clutch coupling that is rotated by the motor and that operatively engages with a coupling clutch on the underside of the blender jar to cause blades within the blender jar to rotate when the motor is activated.

The housing 16 may comprise separate upper and lower housings, joined together (optionally with a gasket placed between the walls defined by the upper and lower housings) to form a shell creating a hollow space for an electric motor and any corresponding appliance electronics. Alternatively, the housing may be an integral, one-piece shell. The specific shape of the motor housing is not critical. Here, the blender base 16 is a rectilinear shell with four substantially vertical walls, a top side, and a bottom side. The shape of the housing could vary.

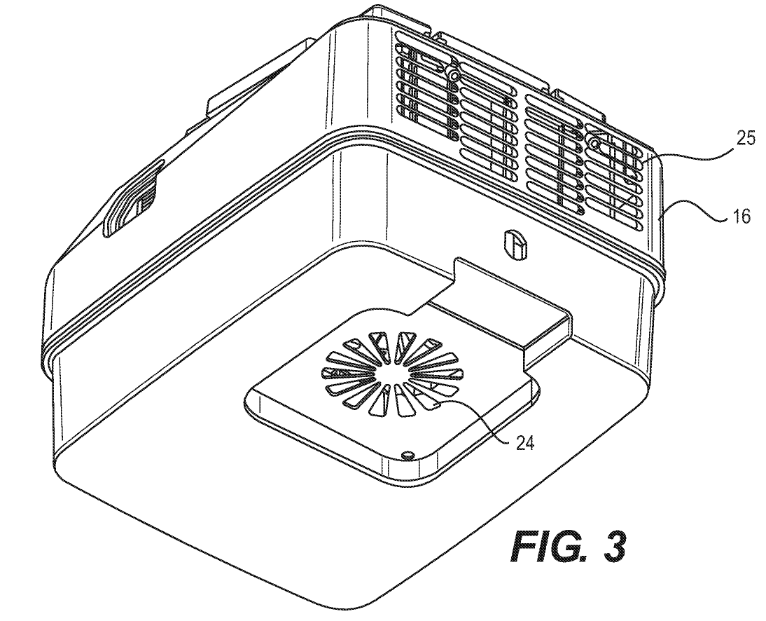

As seen in FIG. 3, a plurality of ventilation holes 24 are defined in the bottom surface of the housing 16, within a depression formed in the bottom surface of the housing. The ventilation holes 24 enable the cooling fan to draw air into the housing 16 and/or to expel air from the housing 16. A plurality of ventilation holes 25 are also defined in the rear surface of the housing 16 to enable the cooling fan to expel air from the housing 16 and/or draw air into the housing 16.

A control panel 18, located on the front side of the housing 16 at a reclined angle, provides a means for a user to input instructions to the blender, and for information to be output to the user. Other than the motor and fan operation described below, the specific operation and features of the blender are not important for the purposes of this disclosure and will not be discussed in detail.

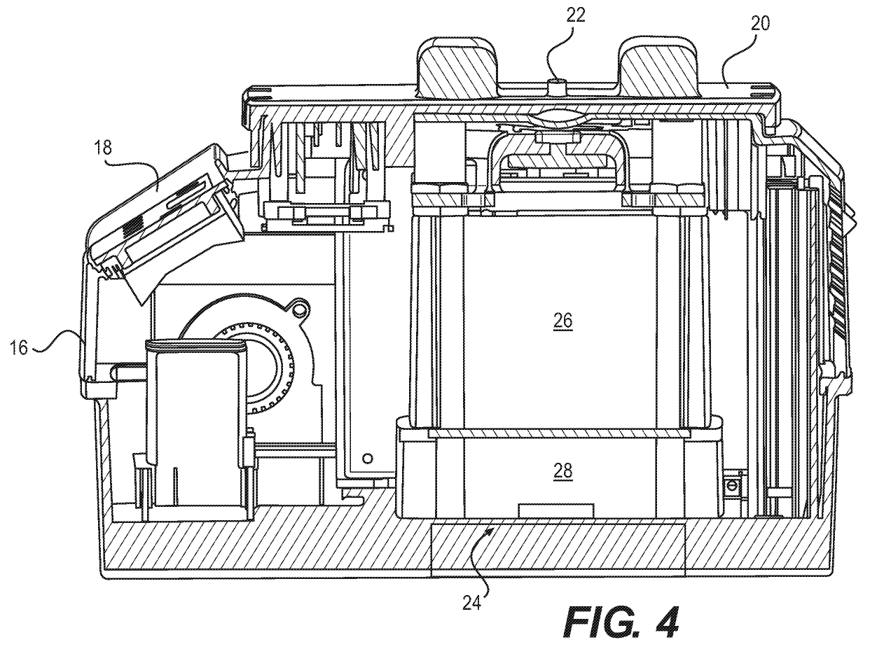

Referring now to FIG. 4, a cross-sectional side view of the housing 16 is illustrated. A motor 26 is positioned within the housing 16, positioned to drive rotatable shaft 22 when the motor 26 is activated. The motor 26 may comprise a conventional universal motor, a brushless DC motor, or any other suitable motor.

Cooling fan 28 is positioned to be able to blow air into or onto the motor 26 (or to pull air through the motor, depending on the direction of air flow from the fan), in this case below the motor 26. The cooling fan 28 may comprise a single speed fan, a multiple speed fan, or a continuously variable speed fan. The cooling fan 28 may be affixed to the bottom end of the motor 26, or the cooling fan 28 may be affixed only to the housing 16 or to a suitable structure within the housing 16. Importantly, however, the cooling fan 28 is not engaged with, mounted to, or in any way driven by the shaft of the motor 26. The cooling fan 28 is independently controllable from the motor 26. In this regard, the cooling fan 28 may operate when the motor is not operating, and the motor 26 may operate when the cooling fan 28 is not operating (in addition to the motor and fan being able to operate at the same time). Additionally, the cooling fan 28 may operate at a different rotational speed than the motor 26 (in addition to being able to operate at the same speed).

Controlling the activation and deactivation of the cooling fan (along with the speed of the cooling fan, if variable) may be based on the sensed temperature of the motor and/or the temperature within the housing. One or more temperature sensors 42 (such as a thermistor or the like) may be affixed in, on, or adjacent to the motor to determine the temperature of the motor and/or the temperature within the housing. When the sensed temperature reaches a first predetermined threshold level (which may vary depending on, for example, the specifications of the motor, but in one exemplary embodiment is 50 degrees Celsius), the cooling fan may be activated to cool the motor. The cooling fan may remain activated until the temperature decreases to below a second predetermined threshold temperature (which may vary depending on, for example, the specifications of the motor, but in one exemplary embodiment is 40 degrees Celsius). The first and second predetermined threshold temperatures would typically differ, but could be the same. In this regard, the cooling fan may first be activated after the motor has been running for some time, as there may be no need to cool the motor when the motor first begins operating. Further, the cooling fan may remain activated for some time after the motor has been deactivated, as the temperature may remain above the threshold even after the motor has ceased operating. If the cooling fan is multiple or variable speed, the speed at which the cooling fan is operated may vary depending on how far above the threshold the temperature is. This independent control of the motor and the cooling fan provides more precise temperature control, which may extend the operating life of the motor.

The blender 10 comprises a controller 40 for controlling one or more operations of the kitchen appliance. The controller 40 communicates with the control panel 18 to receive user input and send outputs. The controller 40 controls the operation of the motor 26, such as the amount of time the motor operates and the one or more speeds at which the motor operates, based on user input and/or preprogrammed instructions. The controller 40 receives temperature data from one or more temperature sensors 42. The controller 40 controls the operation of the fan 28, such as the amount of time and when the fan operates (and the one or more speeds at which the fan operates, if the fan has more than one speed), based on the temperature data and/or preprogrammed instructions. The controller 40 may comprise a microprocessor, dedicated or general purpose circuitry (such as an application-specific integrated circuit or a field-programmable gate array), a suitably programmed computing device, or any other suitable means for controlling the operation of the blender.

It should be noted that while the primary preferred embodiment described herein relates to a blender motor and associated cooling fan, the teachings herein may be applied to many different types of appliances that have electric motors that need to be cooled during operation. The independent control of the motor and cooling fan is thought to be advantageous for the above-described reasons. Benefits of using the disclosed motor/fan arrangement with other kitchen appliances will become apparent to one of skill in the art.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

That which is claimed:

1. A blender for blending foodstuff, the blender comprising:
a base enclosing a motor and a cooling fan, the cooling fan selectively operable and positioned to blow or draw air across at least a portion of the motor;
a blender jar removably mountable to the base, the blender jar having one or more selectively rotatable blades;
wherein the motor is selectively operable to rotate the blender jar blades;
wherein the selective operation of the motor is independent of the selective operation of the fan, such that (1) the fan is operable when the motor is not operating, (2) the motor is operable when the fan is not operating, and (3) the fan and the motor are operable at different respective speeds at a same time.

2. The blender of claim 1, further comprising a thermostat for measuring a temperature of the motor;
wherein the fan operates when the measured temperature is above a first predetermined temperature limit; and
wherein the fan does not operate when the measured temperature is below a second predetermined temperature limit.

3. The blender of claim 2, wherein the first predetermined temperature limit is not equal to the second predetermined temperature limit.

4. A method of operating a blender for blending foodstuff, the method comprising:
(a) receiving a user input via a control panel of a blender, the blender comprising:
a base enclosing a motor and a cooling fan, the cooling fan selectively operable and positioned to blow or draw air across at least a portion of the motor;
a blender jar removably mountable to the base, the blender jar having one or more selectively rotatable blades;
wherein the motor is selectively operable to rotate the blender jar blades;
wherein the selective operation of the motor is independent of the selective operation of the fan, such that (1) the fan is operable when the motor is not operating, (2) the motor is operable when the fan is not operating, and (3) the fan and the motor are operable at different respective speeds at a same time;
(b) operating the motor as indicated by the user input;
(c) measuring a temperature of the motor;
(d) comparing the measured temperature to a first predetermined temperature limit and to a second predetermined temperature limit;
(e) operating the fan if the measured temperature is above the first predetermined temperature limit; and
(f) not operating the fan if the measured temperature is below the second predetermined temperature limit.

5. The method of claim 4, wherein the first predetermined temperature limit is not equal to the second predetermined temperature limit.
